(19) United States
(12) Patent Application Publication
(10) Pub. No.: US 2015/0328791 A1
(43) Pub. Date: Nov. 19, 2015

(54) Utility Knife

(71) Applicant: Ralph Jones, Hampton, GA (US)

(72) Inventor: Ralph Jones, Hampton, GA (US)

(21) Appl. No.: 14/723,569

(22) Filed: May 28, 2015

Related U.S. Application Data
(63) Continuation-in-part of application No. 14/144,974, filed on Dec. 31, 2013.
Application No. 14/144,974 is a continuation-in-part of application No. 13/486,534, filed on Jun. 1, 2012, now Pat. No. 9,056,399.

(51) Int. Cl. B26B 27/00; B26B 3/08

(52) U.S. Cl. CPC B26B 27/007; B26B 3/08

(57) ABSTRACT

The utility knife device generally comprises a blade housing covering a portion of the user's hand, including a casing, a blade and a trigger. The blade housing is made up of a casing which preferably encloses the user's index finger, a blade housed within the casing and a trigger which extends out of the casing and manipulates the blade. The blade is capable of extending outward from the casing being held in place for use. The blade is also capable of automatically retracting within the casing so that the blade is not exposed.

### CROSS-REFERENCES TO RELATED APPLICATIONS

This non-provisional application is a continuation-in-part of U.S. application Ser. No. 14/144,974, filed on Dec. 31, 2013, which is a continuation-in-part of U.S. application Ser. No. 13/486,534. The prior application was filed on Jun. 1, 2012. It is listed as the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of devices for utility knives. More specifically, the invention comprises a retractable utility knife attachable to the hand of a user.

2. Description of the Related Art

Many tasks require use of a razor blade. Stockroom jobs are among many jobs which often require an individual to carry a razor blade or cutting knife on his/her person. A stockroom worker, such as a grocery store stocker, is required to open multiple cardboard boxes throughout the day. In order to open a box, the worker must retrieve the cutting tool from his/her pocket, slice the box and return the tool to his/her pocket or belt. The worker is unable to move quickly from box to box and can leave the cutting tool behind if she/he sets it down. Additionally, the cutting tool is often left exposed and can result in accidental injury to the worker's hand or body.

There are many cutting tools that can be used to open a box. However, no cutting tool is capable of being attached to a user's hand in a safe manner such that the user can expose and retract a blade with the use of one hand. Additionally, the blade is capable of locking in place to simply and efficiently cut the likes of a cardboard box open.

Therefore what is needed is a utility knife which allows simple and efficient slicing of an object, such as a cardboard box. The present invention achieves this objective, as well as others that are explained in the following description.

### BRIEF SUMMARY OF THE INVENTION

The present invention comprises a utility knife device which fits over and is thereby attached to a user's hand or index finger. The utility knife device is generally comprised of a blade housing which attaches to a user's finger using a strap. The blade housing is made up of a casing which preferably encloses the user's index finger, a blade housed within the casing and a trigger which extends out of the casing and manipulates the blade. The blade is capable of extending outward from the casing for use and retracting within the casing so that the blade is not left exposed.

The utility knife preferably allows the user to fully maneuver his or her hand while the device is attached to the index finger. In addition, the utility knife preferably includes other features which are useful while the device is attached. For example the utility knife preferably includes a plastic protrusion that can be used to cut tape while opening boxes containing items that cannot be cut with a sharp blade.

### BRIEF DESCRIPTION OF THE SEVERAL VIEWS OF THE DRAWINGS

FIG. 1 is a perspective view, showing the present utility knife device with the blade exposed.

FIG. 2 is a perspective view, showing the present utility knife device with the blade retracted.

FIG. 3 is a perspective view, showing the present utility knife ejecting the blade.

FIG. 4 is a perspective view, showing the present utility knife from above.

FIG. 5 is an exploded view, showing several component parts of the assembly within the blade housing.

FIG. 6 is a cross section view, showing the blade housing.

FIG. 7 is a perspective view with the blade housing and blade itself cut away to show the interaction of lock track and lock pole.

FIG. 8 is a perspective view, showing an alternate embodiment of the present invention.

FIG. 9 is a sectional view, showing an alternate blade housing of the present invention.

FIG. 10 is a perspective view, showing an alternate embodiment of the present invention.

FIG. 11 is a perspective view, showing the blade extension in the alternate embodiment described in FIG. 10.

FIG. 12 is a perspective view, showing the advantage of the embodiment of FIG. 10.

FIG. 13 is a perspective view, showing the application of the embodiment of FIG. 10.

FIG. 14 is a perspective view, showing an alternate embodiment of the present invention.

FIG. 15 is a perspective view, showing the underside of the embodiment of FIG. 14.

FIG. 16 is a perspective view, showing the embodiment of FIG. 14.

FIG. 17 is a perspective view, showing the embodiment of FIG. 14.

FIG. 18 is a perspective view, showing the embodiment of FIG. 14 where the blade housing is open.

FIG. 19 is a perspective view, showing the embodiment of FIG. 14 where the blade housing is open and the blade is removed.

FIG. 20 is a perspective view showing, the embodiment of FIG. 14 cutting an object.

REFERENCE NUMERALS IN THE DRAWINGS

| | | | |
|---|---|---|---|
| 10 | utility knife device | 12 | sheath |
| 14 | protective cover | 16 | tip cover |
| 18 | blade housing | 20 | casing |
| 22 | trigger | 24 | lock track |
| 26 | blade | 28 | wrist portion |
| 30 | soft cover | 32 | connection point |
| 34 | strap | 36 | knuckle portion |
| 38 | lock pole | 40 | pole spring |
| 42 | blade tray | 44 | groove |
| 46 | tray floor | 48 | strap opening |
| 50 | alternate embodiment | 52 | series of straps |
| 54 | alternate blade housing | 56 | channels |
| 58 | positioning slope | 60 | spring |
| 62 | slide channel | 64 | user's first digit |
| 66 | secondary knuckle | 68 | strap |
| 70 | blade opening | 71 | adjustment knob |
| 72 | user's second digit | 74 | cardboard box |
| 76 | gripping surface | 78 | ridges |
| 80 | protrusion | 82 | tab |
| 84 | pivot point | 86 | blade recess |
| 88 | blade centering knob | 90 | magnet |
| 92 | central hole | 94 | user's thumb |

### DETAILED DESCRIPTION OF THE INVENTION

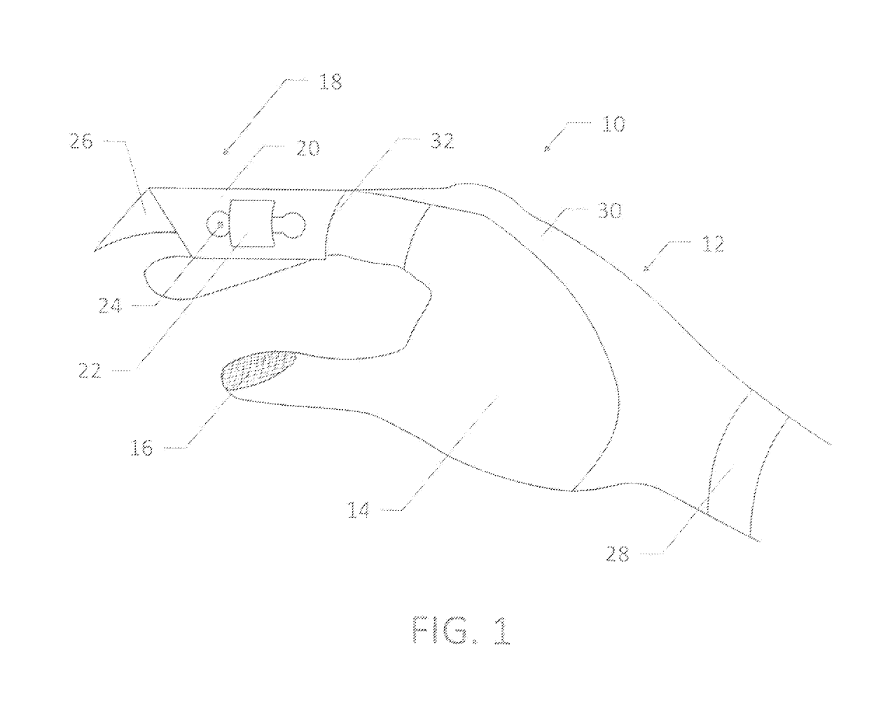

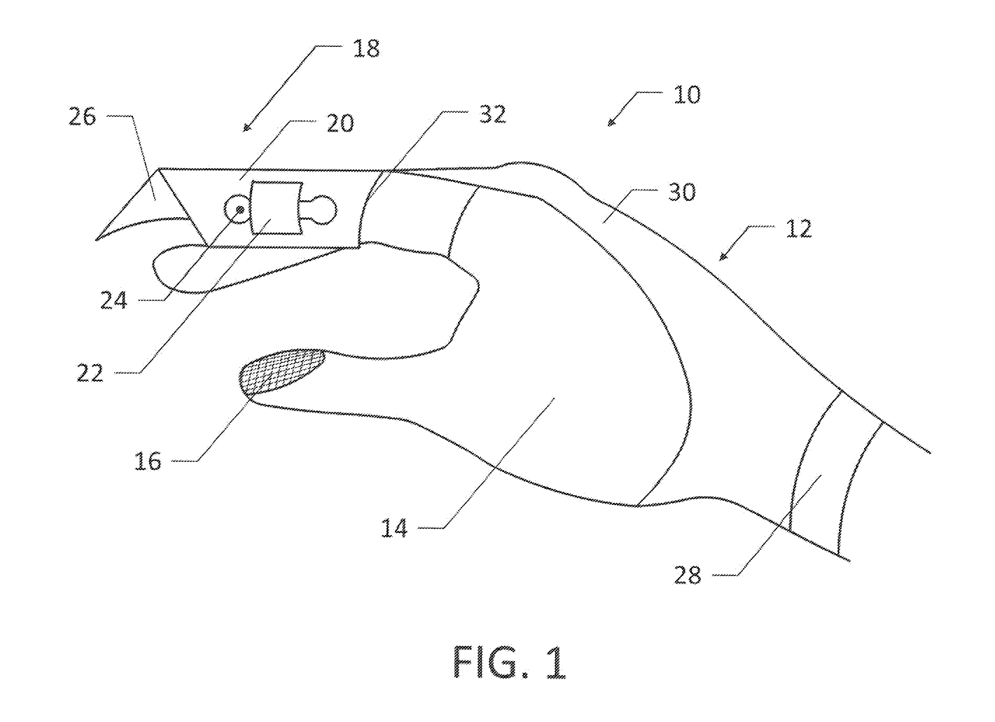

FIG. 1 illustrates the present invention in a first embodiment. The utility knife device 10 consists of sheath 12 connected to blade housing 18. Blade housing 18 includes casing 20 and trigger 22. Casing 22 is attached to sheath 12 at connection point 32. Trigger 22 is movably connected to blade 26 housed within casing 20. Blade housing 18 can be any shape which fits around a user's finger, preferably the user's index linger. Additionally, blade housing 18 can be made of any material which is capable of safely securing a blade inside. Blade housing 18 is connected to sheath 12 by any known method of secure connection at connection point 32. Examples of connection methods between two materials include the use of a heat seal, glue, chemical seal or threading the materials of blade housing 18 and sheath 12 together. Sheath 12 is preferably a glove which covers the user's hand and is held in place by wrist portion 28. Wrist portion 28 can be made of elastic or include a strap for attachment by way of a hook and loop connection, such as Velcro®.

Sheath 12 can be made up of one sturdy material but is preferably comprised of a protective cover 14 and soft cover 30. Protective cover 14 is made of a material which is resistant to puncturing but malleable enough to bend. Soft cover 30 covers the remainder of the hand and can be made of a less versatile material, such as cotton, vinyl or polyester. A tip cover 16 is optionally added to the user's thumb opposite the blade 26. Tip cover 16 is made up of a hardened material which is very difficult or impossible to penetrate with blade 26.

In the present illustration blade 26 is shown extending from casing 20 such that the user can make a cut with blade 26. An optional shield located near or around blade 26 can be added as an additional safety feature. Blade 26 is preferably held into place outside of blade housing 18 when pressure is put on trigger 22 by the user. The current view shows trigger 22 in the middle position of lock track 24. When the user releases trigger 22 it is preferable that the blade 26 springs back into blade housing 18 for safety purposes. This feature requires that the user provide some pressure on trigger 22 to operate blade 26. However, note that in the alternative the blade 26 can be designed to lock into place in its current position in lock track 24, as further defined, such that the user is not required to place pressure on trigger 22 when making a cut.

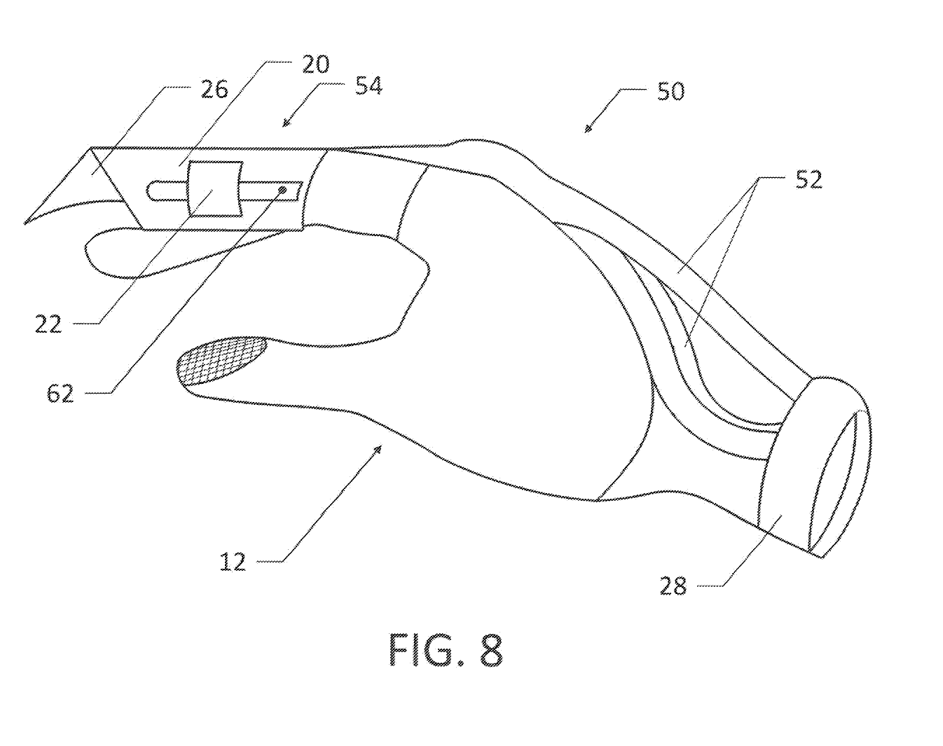

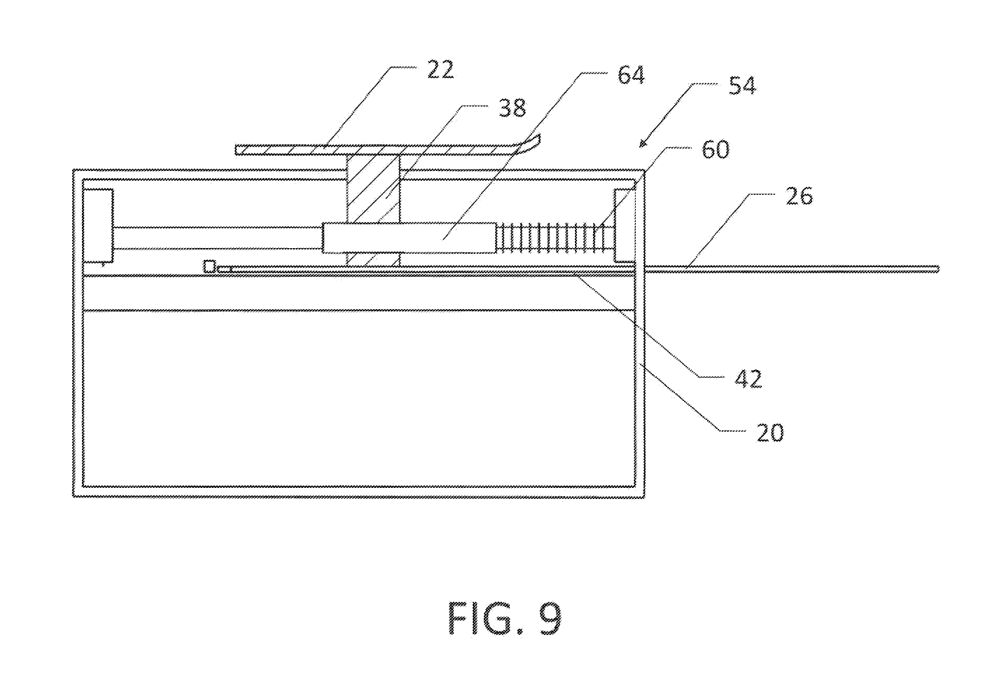

Blade 26 is shown as a razor blade which is curved or hooked downward so that the user can easily extend blade 26 by slightly depressing trigger 22 and moving trigger 22 into position. However, the shape of blade 26 is not limited to the illustrated design. Instead, the blade can be designed in any manner which allows the user to make an appropriate cut. Once held in place or locked in place, blade 26 can be used to make a cut, such as slicing open a cardboard box or cutting a carpet for use. Trigger 22 is purposefully positioned on casing 20 along the side of index finger for the purpose of allowing the user to—with one hand action—extend and use blade 26. After activating trigger 22, blade 26 would either spring back into position within blade housing 18 (as illustrated in FIGS. 8 and 9) or the user would retract blade by placing pressure on trigger 22. In either method of retracting the blade 26, the user can easily reach trigger 22 with his/her thumb tip to manipulate trigger 22 into the appropriate position.

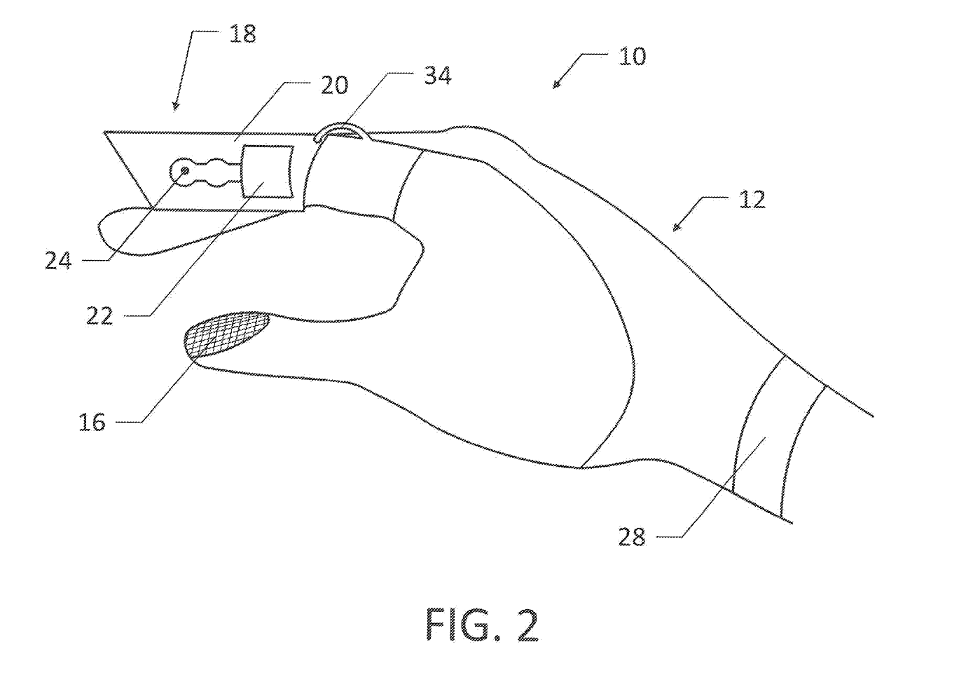

FIG. 2 illustrates the present utility knife 10 with the blade 26 (not shown) fully retracted within blade housing 18. Trigger 22 is shown in the initial position on lock track 24. When the trigger is in this position, the user can easily carry the blade in an accessible but safe manner. The user is still able to work on tasks that do not require the use of the blade. A strap 34 is shown attaching casing 20 to sheath 12. However, the connection between casing 20 and sheath 12 can consist of multiple straps or any other type of attachment or connection method, as discussed above.

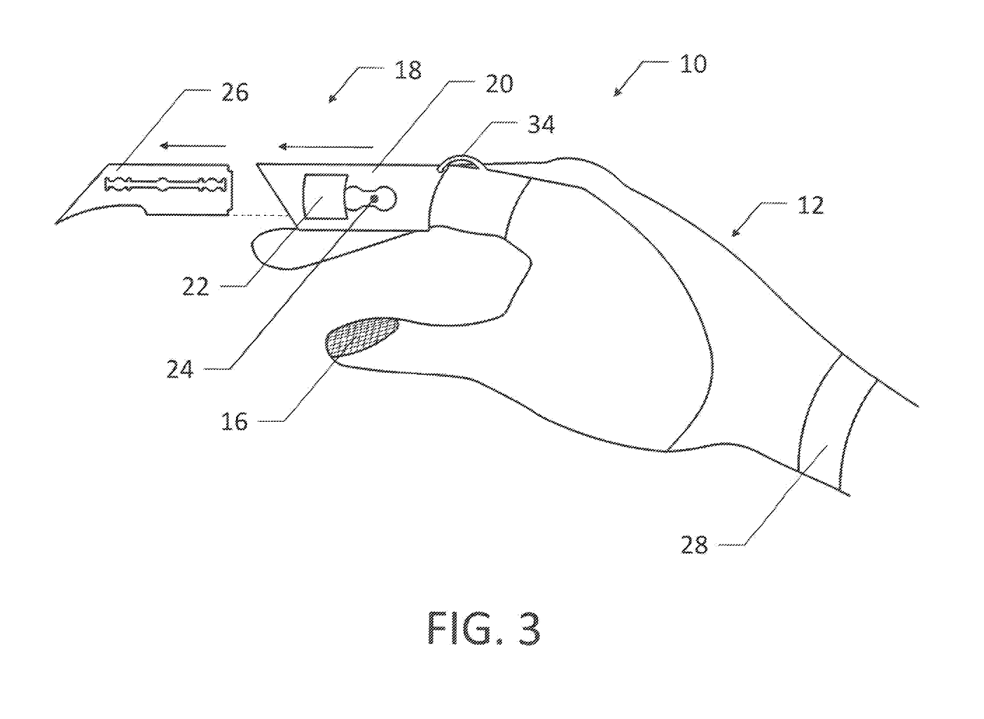

As illustrated in FIG. 3, blade 26 can be ejected from casing 20 to easily change a dull or broken blade. Arrows illustrate the ejection of blade 26 from casing 20. In the preferable method, trigger 22 is pushed to the last position on lock track 24. Trigger 22 lift slightly upward to release blade 26 when in the illustrated position on lock track 24. Any known method of extracting an old blade from blade housing 18 can be used. As an example, the blade housing 18 could be opened and the blade 26 changed in that manner as well.

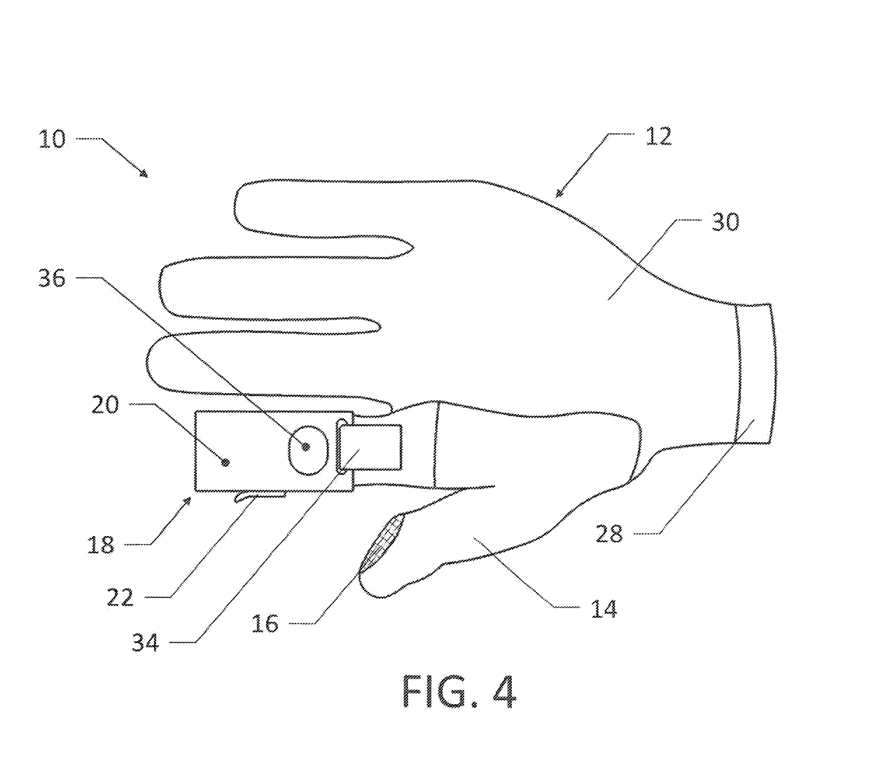

FIG. 4 shows a top view of the present utility knife device 10. The users hand is generally covered by the device 10. Blade housing 18 encloses the index finger of the user. It is desirable that the full index finger is not enclosed by blade housing 18, but instead, the index finger is covered from the tip to the middle joint, thereby allowing the finger to bend. However, the device should not be limited to this functionality. Instead blade housing 18 may cover the entire finger and/or portions of sheath 12. Additionally, although blade housing 18 appears non-malleable, blade housing could be made of a hardened, semi-malleable material to allow some limited movement.

In one embodiment a cut out or grip is provided at the user's knuckle. Knuckle portion 36, as shown, is simply an opening in casing 20 which allows additional room to bend the index finger. The opening can be optionally covered with fabric. However, knuckle portion 36 could also be a grip, made of material which provides frictional engagement with the user's knuckle, located on the inside of the casing 20. The optional grip would allow additional stability to grip and hold the blade steady while making a cut.

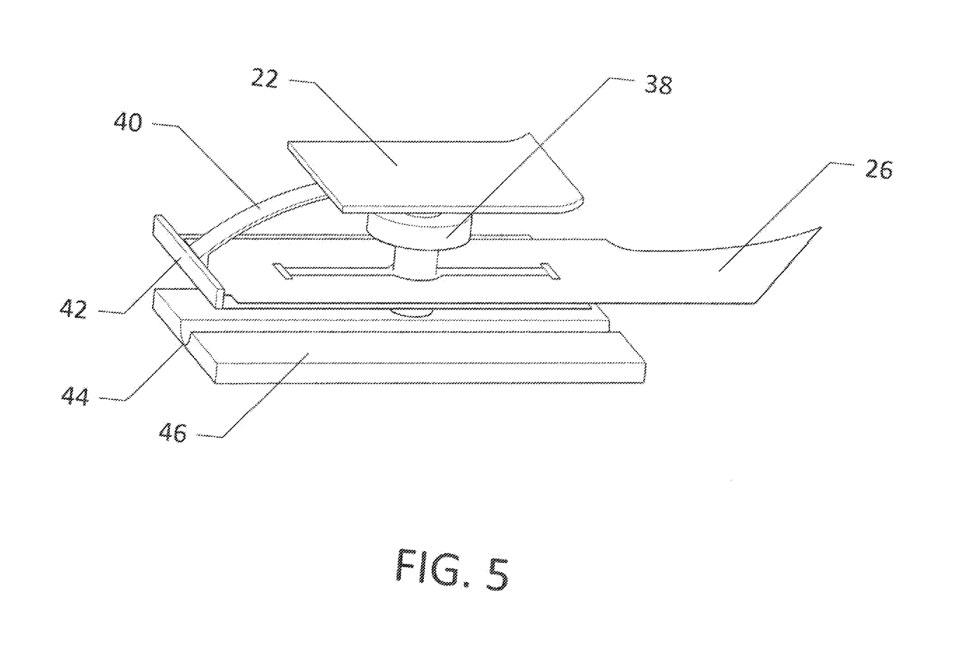

One method of extending and retracting blade 26 is illustrated in FIGS. 5-7. However, any known method of providing an extendable and retractable blade can be used in the present invention. The invention should not be limited to the example shown.

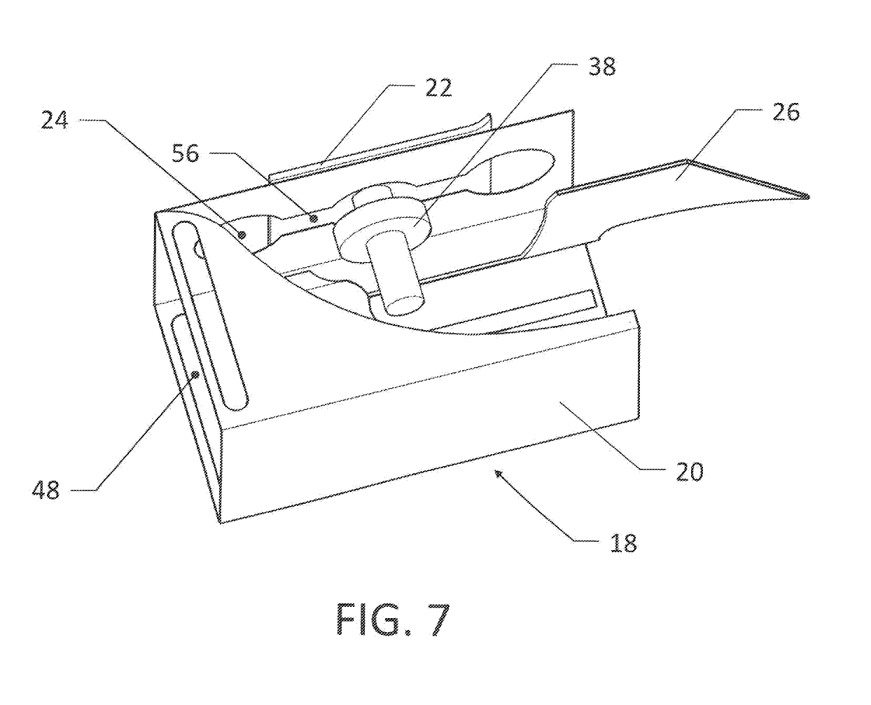

An expanded parts view of functional component parts of the blade housing is shown in FIG. 5. Casing (not shown) is removed from the illustration for purposes of clarity. Trigger 22 attaches to a lock pole 38 which has a portion with a small diameter and a portion with a larger diameter. Turning to FIG. 7, a perspective view with casing 20 and blade 26 cut away is shown. The action between trigger 22, lock pole 38 and lock track 24 is illustrated. When trigger 22 is depressed the portion of lock pole 38 with the small diameter is capable of sliding through lock track 24, through channels 56, to reach any position. Channels 56 are designed to correspond with the smaller diameter size of lock pole 38. Upon release of trigger 22, lock pole 38 pops back up into place such that the portion of lock pole 38 with the larger diameter fits into the corresponding desired position of lock track 24. Thus, the lock pole 38 is locked in place (since the portion of lock pole 38 with the larger diameter is incapable of fitting through the narrow channels 56 on lock track 24).

Returning to FIG. 5, pole spring 40 provides resistance for trigger 22 and lock pole 38. The pole spring 40 allows for the depression of lock pole 38 enough for the portion of lock pole 38 with the larger diameter to fit under casing 20 and thereby under the narrow channels 56 along lock track 24 (as illustrated in FIG. 7). For illustration purposes, pole spring 40 is shown larger than would be necessary in order to achieve the spring-like effect. Additionally, pole spring could be attached to the lock pole 38 underneath the casing 20 so as not to interfere with lock track 24.

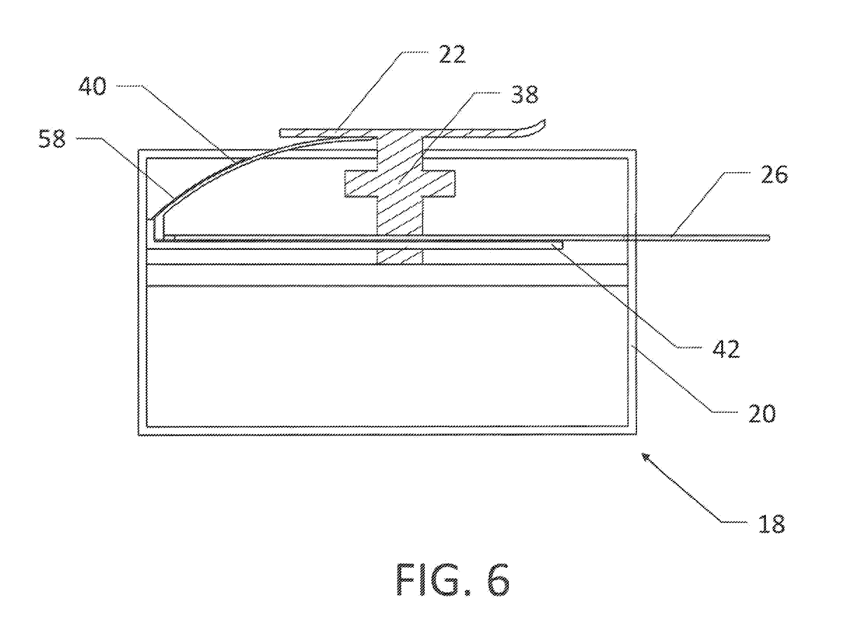

FIG. 6 is a cross section view of blade housing 18. A positioning slope 58 within casing 20 provides a guide for pole spring 40 which connects trigger 22 and lock pole 38 to blade tray 42. Lock pole 38 engages blade 26, which sits securely in blade tray 42. When trigger 22 is depressed and slid by user, lock pole 38 causes blade 26 and blade tray 42 to shift as well.

In FIG. 7, strap opening 48 is also shown, as a method of attaching casing 20 to sheath 12 (not shown). Note. FIG. 7 is for illustrative purposes to show lock pole 38 and lock track 24 and therefore does not illustrate blade tray, pole spring and several other features of the present method of retracting blade 26.

An alternate embodiment 50 of the present invention is shown in FIG. 8. In the alternate embodiment 50, sheath 12 only covers the user's index finger and thumb. A series of straps 52 connects sheath 12 to wrist portion 28. Thus, the user's other three fingers are left free and exposed. Additionally, an alternate blade housing 54 is illustrated. The alternate blade housing 54 can also operate by a press and slide motion of a trigger 22 along a slide channel 62 located on casing 20. However, as illustrated slide channel 62 is one long thin channel. As further illustrated in FIG. 9 alternate blade housing 54 has a spring 60 housed within casing 20. Lock pole 38, attached to trigger 22, engages spring post 64, blade 26 and blade tray 42. When user engages trigger 22 and slides lock pole 38 along slide channel 62 to expose blade 26, spring post 64 and spring 60 are thrust forward, compressing spring 60. Blade 26 and blade tray 42 move in conjunction with spring post 64, exposing blade 26 outside of casing 20. A partial frictional engagement can be provided such that when the blade 26 is in the fully exposed position, the blade 26 is partially held into place by the frictional engagement (such engagement can be provided in any known manner, such as narrowing of slide channel closer to the front or exit point of blade 26). Upon release of pressure on trigger 22, spring 60 releases tension and pulls blade 26 back within casing 20.

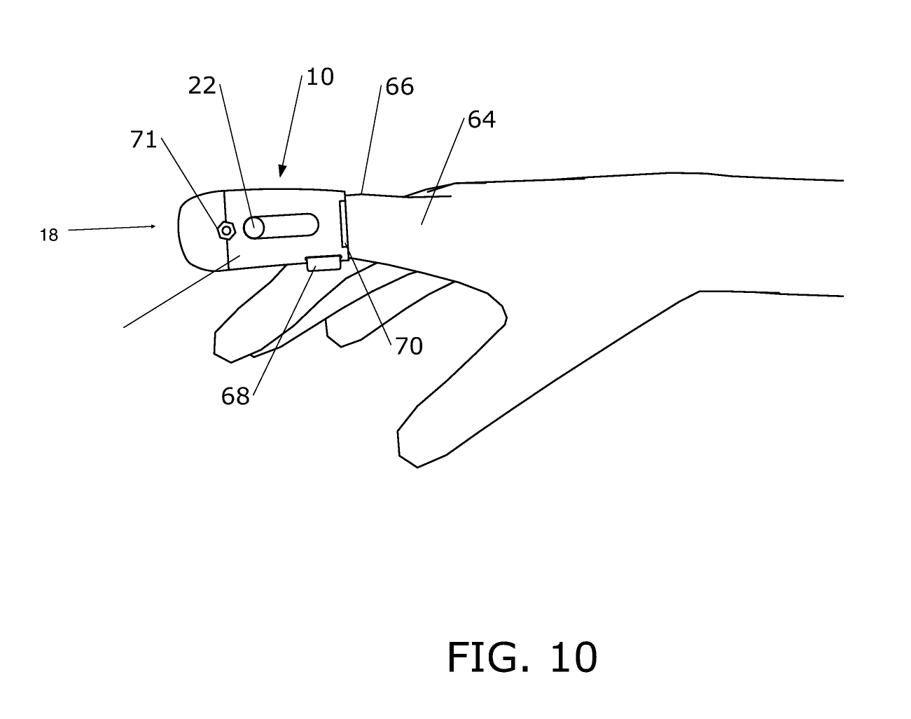

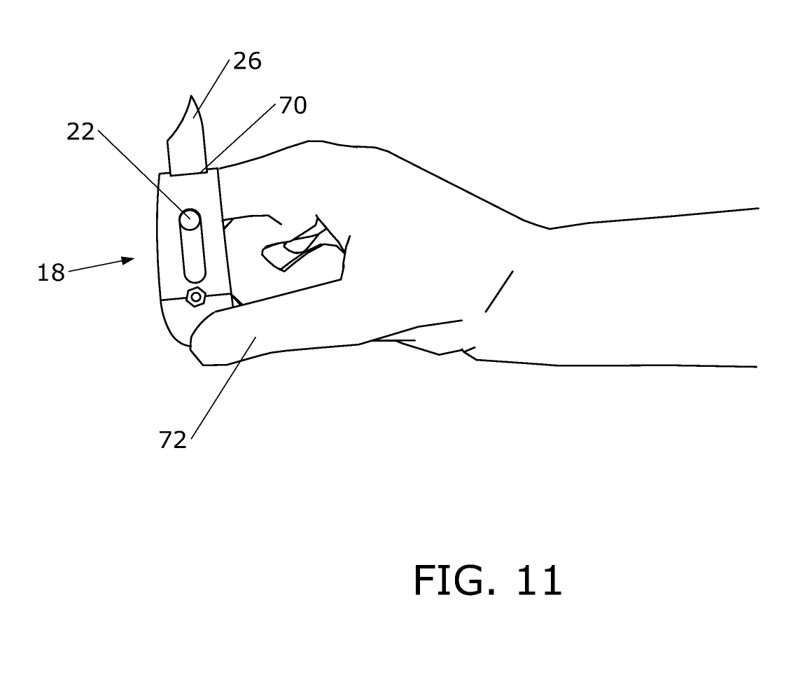

Another embodiment of the present invention is illustrated in FIG. 10. Utility knife device 10 slides over user's first digit 64. However, unlike the previously described embodiment, this embodiment fits over the tip of the user's first digit 64, similar to a thimble used for sewing. Utility knife device 10 encompasses user's first digit 64 up to secondary knuckle 66, without covering the secondary knuckle 66 of the user. The significance of the ability of the user's secondary knuckle 66 to bend will be made clear in the subsequent text. Utility knife device 10 includes blade housing 18 and strap 68. Blade housing 18, having a forward end and an all end, covers user's first digit 64 and includes blade 26 (not shown), trigger 22, casing 20, and adjustment knob 71. Blade housing 18 is secured to user's first digit 64 by way of strap 68. Trigger 22 is in the closed position in the current view. By translating trigger 22 toward blade opening 70, the blade of utility knife device 10 exits blade opening 70 at the aft end of blade housing 18. The blade 26 (shown in FIG. 11) exits the device 10 in a rearward (“aft”) manner, back towards the user's hand if the user's first digit 64 is fully extended.

In order to accommodate varying hand and finger size, the alternate embodiment shown in FIG. 10 preferably includes adjustment knob 71. By rotating adjustment knob 71, a user is capable of increasing or decreasing the length of utility knife device 10. Thus, the present invention provides a universal fit.

FIG. 11 shows the embodiment shown in FIG. 10 with blade 26 extended. The reader will observe that trigger 22 is now in the open position (closest to blade opening 70). Similar to the embodiment shown in FIGS. 8 and 9, the user can easily slide trigger 22 with second digit 72 in order to extend or retract blade 26. It is also noteworthy that the user is capable of bending his or her first digit 64 at the secondary knuckle 66 (not shown as it is hidden by blade housing 18). This allows for a significant amount of flexibility in the user's first digit despite attachment to the blade housing 18.

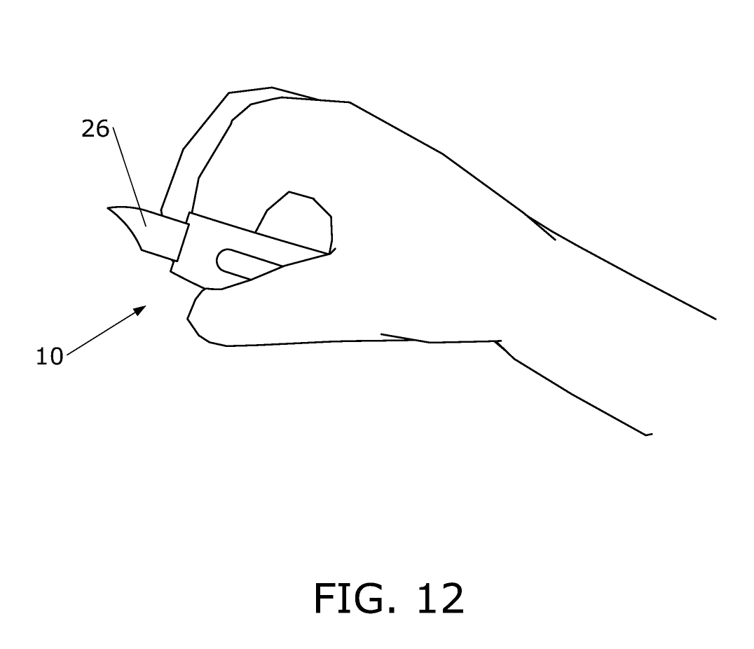

FIG. 12 illustrates an advantage of using this particular embodiment of the present invention. Once the user creates a fist with his or her hand, utility knife device 10 is directed in such a way that blade 26 is directed away from the user, as shown. The advantage of this configuration is realized by the leverage created when the user's hand is in this position. To those familiar with the art, it is understood that a user has more of a leverage advantage with the configuration shown in FIG. 12 than the previous embodiment described. This is due to the primary components providing the force to cut an object. In the current embodiment, the force is created with the user's wrist and arm, whereas the force in the previous embodiment relies on the strength of the user's first digit. This allows the user to cut thicker and stronger materials with utility knife 10.

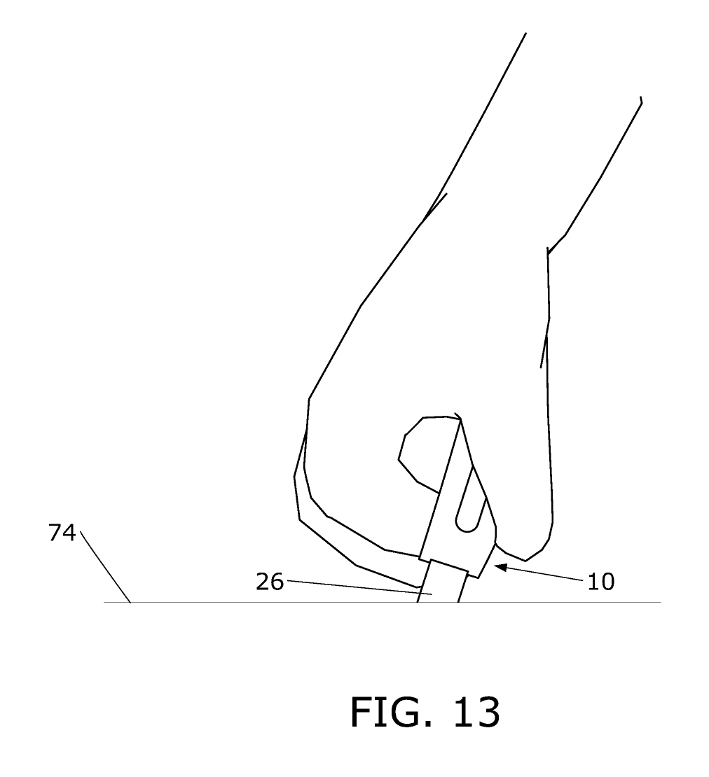

FIG. 13 shows an application of the present invention. Utility knife device 10 is in the “blade open” configuration. Blade 26 is inserted into the object to be cut, such as cardboard box 74. Upon cutting the desired object, the user may move on to the next object or retract blade 26 in order to perform other duties. This is accomplished with the current invention still attached to the user's first digit.

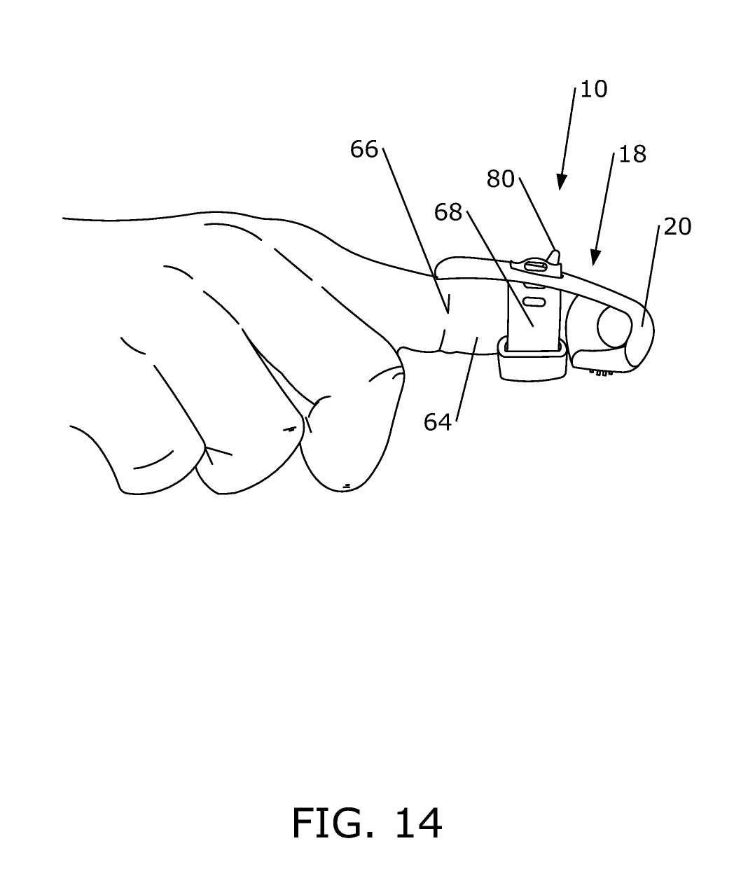

FIG. 14 shows a preferred embodiment of the present invention. Utility knife device 10 primarily comprises blade housing 18 (including casing 20, blade 26 and trigger 22) and strap 68. Although the term “blade housing” is commonly defined as a covering or case, the definition for purposes of the present invention includes not only the casing itself but also the blade and trigger. The term is further defined and depicted by reference numeral 18 in the Figures. Similar to the embodiment shown in FIGS. 10-13, the embodiment of utility knife device 10 shown in FIG. 14 is attached to the user's first digit 64 (index finger) via strap 68. Strap 68 can be adjusted to fit first digit 64 of the user. Strap 68 is positioned above the user's secondary knuckle 66. Once the user adjusts strap 68, he or she cant easily remove and replace utility knife device 10. The reader will note that blade housing 18 is not as bulky as the embodiment shown in FIGS. 10-13. The blade housing 18 in the present embodiment allows for increased comfort and breathability of utility knife device 10. In addition, the reader will note that due to the placement of strap 68 with respect to the user's secondary knuckle 66, the user is able to easily bend his or her secondary knuckle 66. Additionally, casing 20 does not fully enclose the user's first digit 64. As illustrated in FIG. 14, casing 20 cover the top, or dorsal aspect of the user's first digit 64 and the exterior, or thumb side, of the user's first digit 64, curving over the tip of the user's first digit 64. Therefore, even if the casing 20 extends past the user's secondary knuckle 66, casing 20 does not obstruct the flexion of the user's knuckle. The reader will appreciate that the interior side of the user's first digit and a large portion of the palmar aspect of the user's first digit 64 are not inhibited by casing 20.

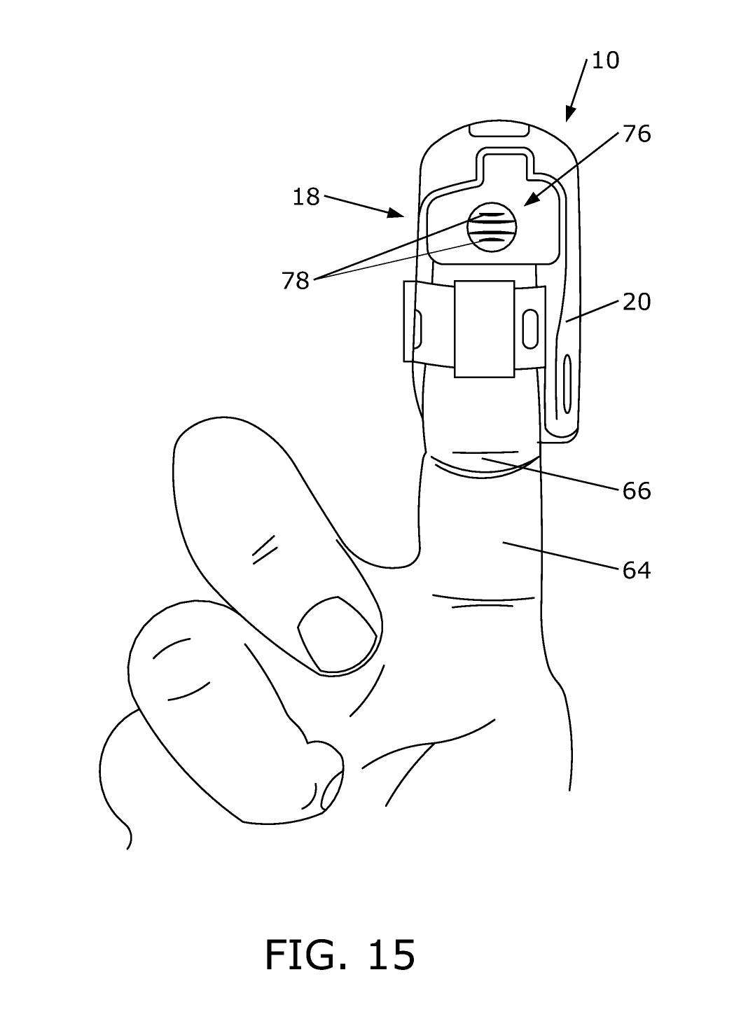

FIG. 15 shows the underside of utility knife device 10 attached to user's first digit 64. Again the reader will note that utility knife device 10 does nut prevent the user from easily bending secondary knuckle 66. Preferably, utility knife device 10 includes gripping surface 76 on the underside of casing 20, as illustrated. Gripping surface 76 allows the user to easily grab and grip objects while utility knife 10 is attached to his or her first digit 64. In one embodiment, gripping surface 76 includes ridges 78, which increase the gripping capabilities of gripping surface 76. In a preferred embodiment, gripping surface 76 is fabricated from a rubber material or soft plastic. Those familiar with the art will realize that gripping surface can be fabricated using a material that tends to increase the coefficient of friction with respect to the object being handled.

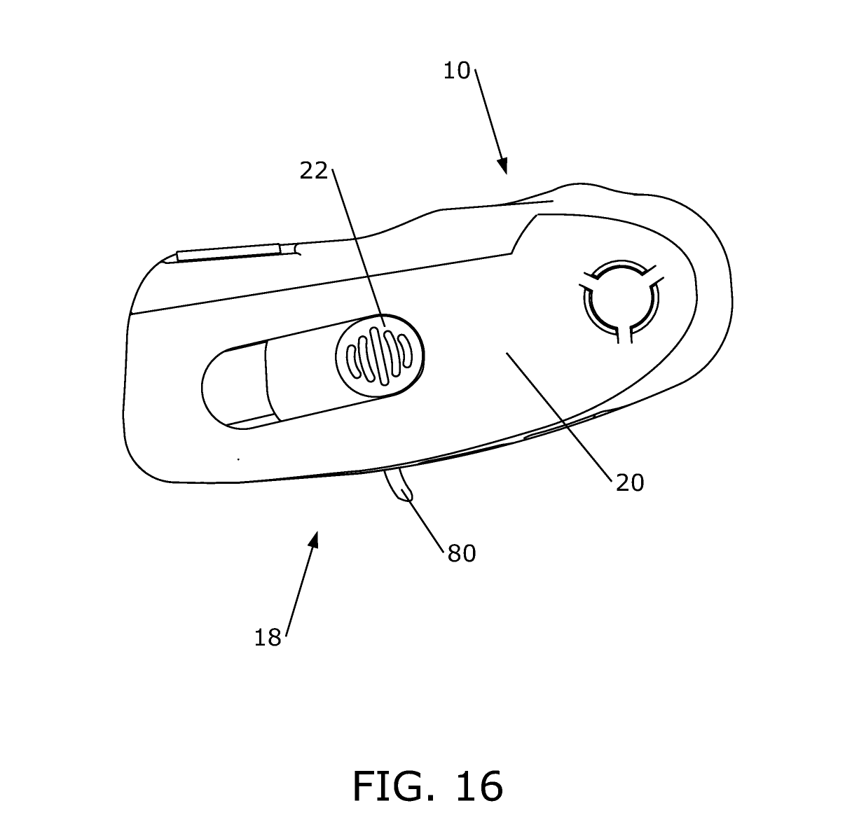

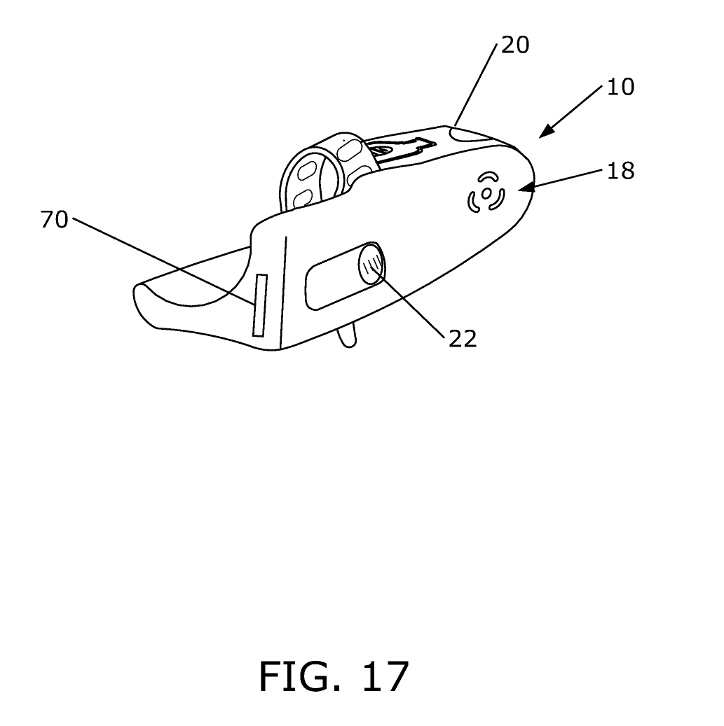

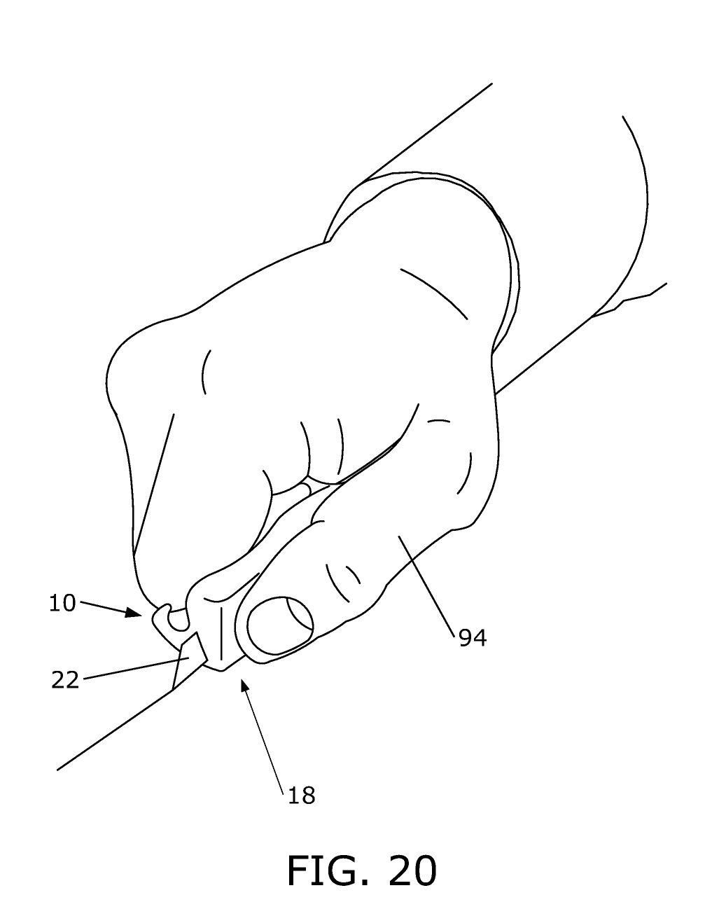

FIGS. 16 and 17 show utility knife 10 (not attached to a user's finger) in order to illustrated additional features. Preferably, utility knife device 10 includes protrusion 80, looking hack at FIG. 14, the reader will note that protrusion 80 is located on the top surface of utility knife 10 when index finger 64 is extended. Therefore, when the user creates a fist with his or her hand, protrusion 80 is located on the surface of utility knife device 10 facing away from the user's hand. While opening boxes containing material which the user does not want to accidentally cut with sharp blade 26 (blade illustrated in FIG. 20), the user can instead use protrusion 80 to cut the material. For example, the protrusion would be capable of splitting tape sealing a box. Such boxes may contain bags of food product or paper products which may be accidentally cut if blade 26 penetrates the box. This is a well-known issue when stocking frozen food and paper products at grocery stores. Thus, protrusion 80 is fabricated from the same material as casing 20—preferably a rigid plastic material such as acrylonitrile butadiene styrene (“ABS”), a common thermoplastic polymer.

The view in FIG. 17 shows that trigger 22 does not protrude beyond the surface of casing 20. Preferably, trigger 22 is level or flush with the surface of casing 20 as illustrated. This prevents the user from unintentionally extending blade 26 while utility knife device 10 is not in use. The user can easily access trigger 22 with his or her thumb when he or she intends to press trigger 22. Trigger 22 is engaged with said blade 26 such that when a force is applied to trigger 22, blade extends out through blade opening 70 (as illustrated in FIG. 20).

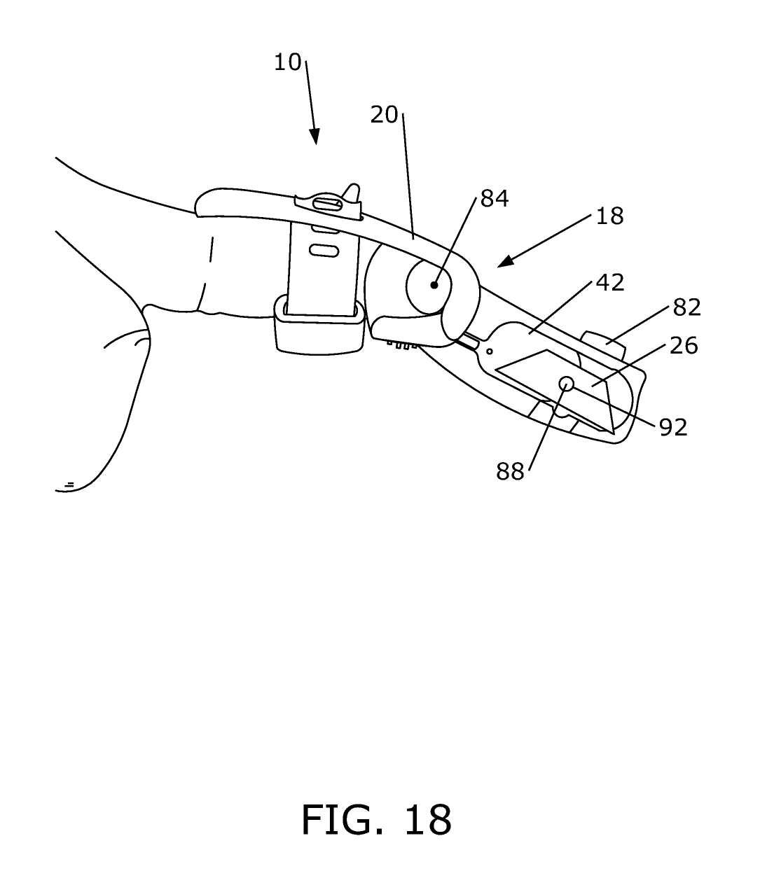

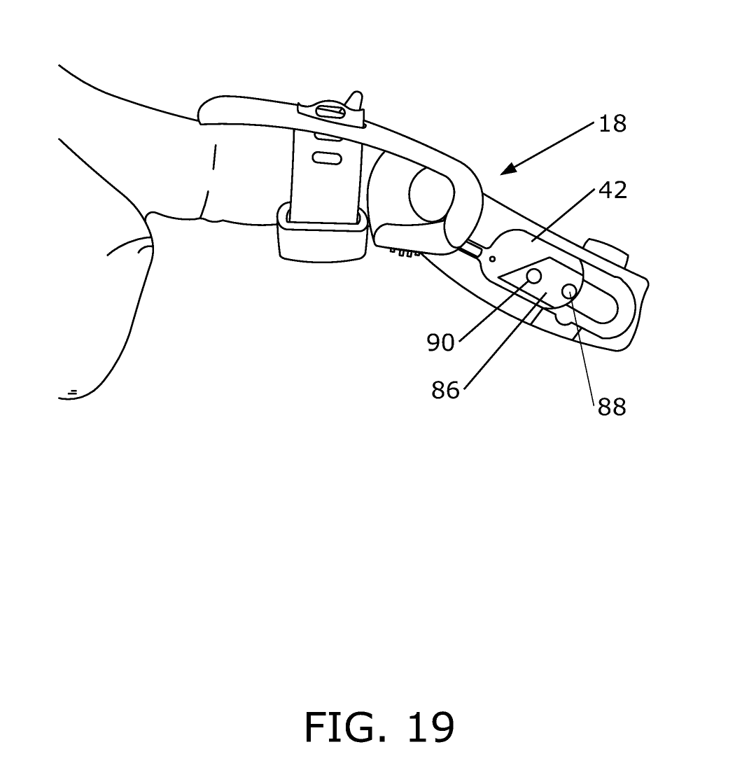

FIGS. 18 and 19 show how blade 26 is contained within casing 20. Preferably, casing 20 is capable of opening in order to replace blade 26. In order to open, blade housing 18 includes a pivot point on the forward end of utility knife 10 and a tab 82 near the aft end. The user presses tab 82 in order to unlock and open casing 20 by rotating blade tray 42 about pivot point 84. FIG. 19 shows blade tray 42 with blade 26 removed. Preferably, blade tray 42 includes blade recess 86, blade centering knob 88, and magnet 90. These components act to correctly position blade 26 within blade tray 42. Magnet 90, such as a neodymium magnet, prevents blade 26 from falling out of blade tray 42 when it is opened. Preferably, blade 26 includes central hole 92 which centering knob 88 fits into, thereby aligning blade 26 in the correct position. Once blade 26 is replaced, blade tray 42 can pivot and click back into position.

FIG. 20 shows a user using utility knife device 10 in order to cut an object. As illustrated, the user's thumb 94 activates trigger 22 (hidden by user's thumb 94). Blade 26 remains extended as long as user's thumb 94 engages trigger 22. This placement of user's thumb 94 stabilizes utility knife 10 while the user cuts an object. If user releases the force provided to trigger 22, blade 26 automatically retracts within casing 20. This automatic retract feature is possible due to the device being spring loaded.

The preceding description contains significant detail regarding the novel aspects of the present invention. It should not be construed, however, as limiting the scope of the invention but rather as providing illustrations of the preferred embodiments of the invention. As an example, the blade housing can provide any known method of providing a trigger which is capable of extending and retracting the blade. Additionally, blade tray can open to expose blade by disengaging fully with casing. Thus, the scope of the invention should be fixed by the following claims, rather than by the example, given.

Having described my invention, I claim:

1. A utility knife device for use by a user having a hand with a first digit and a secondary knuckle, wherein said first digit has a palmar region, a dorsal region, an exterior side and an interior side, said utility knife device comprising:
a. a blade housing having:
i. a casing having a forward and an aft end, configured to enclose at least a portion of said first digit of said user;
ii. a blade contained within said casing;
iii. a trigger connected to said blade; and
b. wherein said trigger can be engaged by said user such that said blade extends out of said ah end of said casing to expose said blade for use.

2. The utility knife device of claim 1, wherein said casing is connected to a strap, wherein said strap is configured to secure said blade housing to said finger of said user.

3. The utility knife device of claim 2, wherein said strap is further configured to secure said blade housing to said first digit by attaching to said first digit above said secondary knuckle of said user.

4. The utility knife device of claim 1, wherein said casing is configured to cover said dorsal region and said exterior side of said first digit.

5. The utility knife device of claim 4, wherein said casing exposes a portion of said palmar region and said interior side of said first digit such that said user is capable of fully flexing said secondary knuckle.

6. The utility knife device of claim 1, wherein said forward end of said casing includes a gripping surface.

7. The utility knife device of claim 1, wherein said casing further comprises:
a. a blade tray; and
b. wherein said blade tray includes a magnet and a centering knob.

8. The utility knife device of claim 7, wherein said blade tray pivots about a pivot point in order to allow access to said blade.

9. The utility knife device of claim 1, further comprising a protrusion attached to said casing such that said protrusion extends away from said casing when said first digit is fully flexed.

10. A utility knife device for use by a user having a hand having a first digit and a secondary knuckle, comprising:
a. a blade housing, having a forward end and an aft end, further comprising a casing, a blade contained within said casing, a trigger engaged with said blade; and a blade opening;
b. a strap attached to said blade housing such that said strap is capable of being removably attached to said first digit of said user above said secondary knuckle;
c. wherein said blade opening is located at said aft end of said casing such that upon engaging said trigger said blade extends out of said blade opening to expose said blade for use when said first digit of said user is in a fully flexed position; and
d. wherein said user can leverage said strength of said hand of said user by bending said finger and applying said blade to said piece of matter with said finger in said fully flexed position.

11. The utility knife device of claim 10, wherein said casing is configured to cover a dorsal region and an exterior side of said first digit.

12. The utility knife device of claim 11, wherein said casing exposes a portion of a palmar region and an interior side of said first digit such that said user is capable of fully flexing said secondary knuckle.

13. The utility knife device of claim 11, wherein said casing further extends around said tip of said first digit to cover a portion of a palmar region of said first digit.

14. The utility knife device of claim 10, wherein said forward end of said casing includes a gripping surface.

15. The utility knife device of claim 13, wherein said casing further comprises a gripping surface proximate said palmar region of said first digit.

16. The utility knife device of claim 14, wherein said gripping surface includes a series of ridges.

17. The utility knife device of claim 10, wherein said casing further comprises:
a. a blade tray; and
b. wherein said blade tray includes a magnet and a centering knob.

18. The utility knife device of claim 17, wherein said blade tray pivots about a pivot point in order to allow access to said blade.

19. The utility knife device of claim 1, further comprising a protrusion attached to said casing such that said protrusion extends away from said casing when said first digit is fully flexed.

20. A utility knife device for use by a user in cutting through a piece of matter having a hand with a first digit, a secondary knuckle and a thumb, said utility knife device comprising:
a. a blade housing, having a forward end and an aft end;
b. wherein said blade housing further comprises a casing surrounding a portion of said first digit of said user, a blade contained within said casing: a trigger configured to operate said blade; and a blade opening located at said aft end of said blade housing;
c. wherein said blade is capable of extending out through said blade housing by applying a force to said trigger when said first digit is in a fully flexed position;
d. wherein said blade automatically retracts when said force is released from said trigger; and
e. wherein said casing further comprises a blade tray capable of pivoting about a pivot point to expose said blade.
